(19) United States
(12) Patent Application Publication
(10) Pub. No.: US 2010/0291256 A1
(43) Pub. Date: Nov. 18, 2010

(54) MOLD FOR FABRICATING CONCAVE LENSES

(75) Inventor: HAN-LUNG LEE, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/576,336

(22) Filed: Oct. 9, 2009

(30) Foreign Application Priority Data
May 14, 2009 (CN) 200910302321.6

(51) Int. Cl. B29C 45/26

(52) U.S. Cl. 425/346

(57) ABSTRACT

An exemplary mold includes a base having a first surface and a second surface at two opposite sides thereof, molding cavities defined in the second surface, convex molding surfaces relative to the first surface, and side surfaces. Each side surface is connected between the second surface and a respective convex molding surface. Each side surface and a corresponding convex molding surface cooperatively define a respective molding cavity. Each convex molding surface is totally received in a respective molding cavity, and a maximum distance between each convex molding surface and the first surface is less than a thickness of the base.

### BACKGROUND

1. Technical Field

The present disclosure relates to optical imaging, and particularly to a mold for fabricating concave lenses, which is used in press-molding.

2. Description of Related Art

Camera modules are widely used in portable electronic devices (e.g., mobile phones). Lenses used in the camera modules of the portable electronic devices are conventionally made by injection molding. Thicknesses of the lenses made by injection molding are usually more than 0.3 millimeters.

Nowadays, the portable electronic devices have become more light-weight, and smaller in volume. Generally, a thickness of the portable electronic device is limited by a height of a camera module received in the portable electronic device. In order to meet the requirement of light-weight and small in volume, sizes of the camera modules and the lenses of the camera modules need to be relatively small. However, it is difficult to produce small lenses with a thickness less than 0.3 millimeters using injection mold.

Therefore, a new mold is desired to overcome the above-mentioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a plan view of a mold according to an exemplary embodiment.

FIG. 2 is a cross-sectional view of the mold of FIG. 1 taken along the line II-II thereof.

FIGS. 3-5 are cross-sectional views showing successive stages of an exemplary method for making a lens array using the mold of FIG. 1.

### DETAILED DESCRIPTION

Embodiments will now be described in detail below with reference to the drawings.

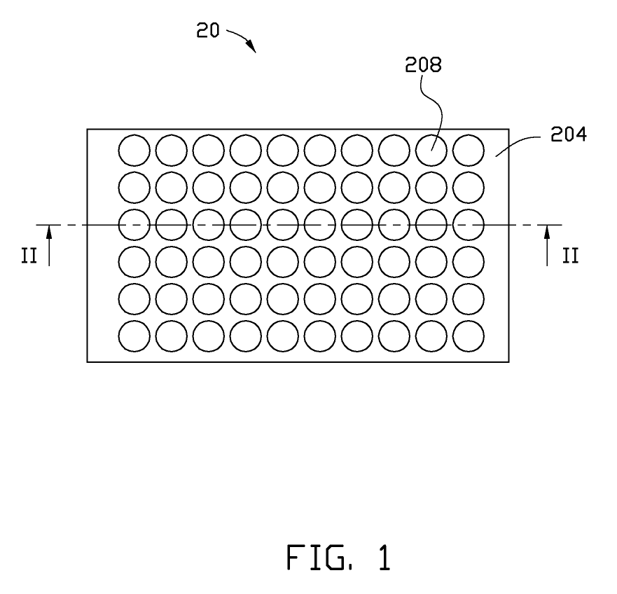

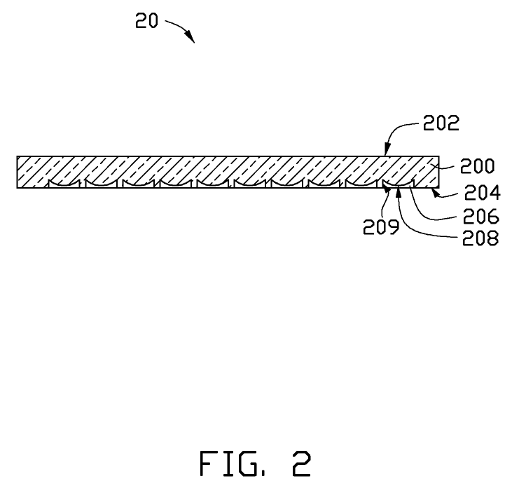

Referring to FIGS. 1-2, a mold 20 according to an exemplary embodiment is shown. The mold 20 includes a base 200 having a first surface 202 and a second surface 204 at two opposite sides thereof, a plurality of molding cavities 206 defined in the second surface 204, and a plurality of convex molding surfaces 208 relative to the first surface 202.

The molding cavities 206 are arranged in a matrix of rows and columns. In the exemplary embodiment, each molding cavity 206 is circular in cross-section. In alternative embodiments, each molding cavity 206 can be other shapes, for example, rectangular. Each molding cavity 206 is defined by a respective convex molding surface 208 and a side surface 209 connected with the convex molding surface 208. Each convex molding surface 208 is positioned between the first surface 202 and the second surface 204, and is entirely received in a corresponding molding cavity 206. A maximum distance between the convex molding surface 208 and the first surface 202 is less than a thickness of the base 200. A minimum distance between the convex molding surface 208 and the second surface 204 is in an approximate range from 1 micron to 300 microns, and particularly, in an approximate range from 100 microns to 200 microns.

In the exemplary embodiment, the side surface 209 is perpendicular to the second surface 204. It should be noted that in alternative embodiments, the side surface 209 can be inclined relative to the second surface 204.

In the present embodiment, each convex molding surface 208 is a spherical surface. It is to be understood that in other embodiments, each convex molding surface 208 can be an aspherical surface.

The mold is made of the material selected from the group consisting of metal, silicon, and polydimethylsiloxane (PDMS).

An exemplary method for fabricating a lens array using the mold 20 will be described below:

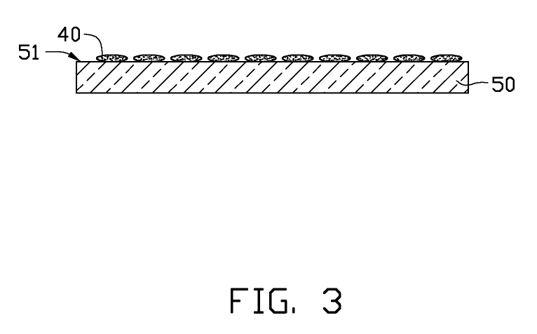

In step 1, referring to FIG. 3, a substrate 50 is provided, and blobs 40 of to-be-solidified optical material are deposited on a surface 51 of the substrate 50 by e.g., a nozzle. The optical material can be, for example, ultraviolet curable polymer. A distance between adjacent blobs 40 is substantially equal to that between adjacent molding cavities 206.

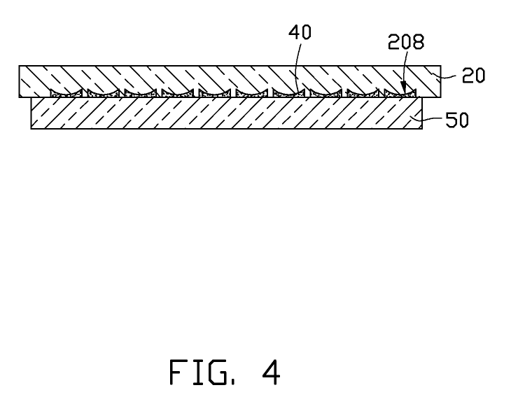

In step 2, referring to FIG. 4, the mold 20 is positioned in such a manner that each blob 40 faces and is aligned with a respective molding surface 208. Then the mold 20 is pressed onto the substrate 50 such that the molding surface 208 press-molds the blobs 40.

In step 3, the press-molded blobs 40 are solidified by, e.g., ultraviolet irradiation to form a lens array, which includes a plurality of lenses 70 arranged in a matrix of rows and columns.

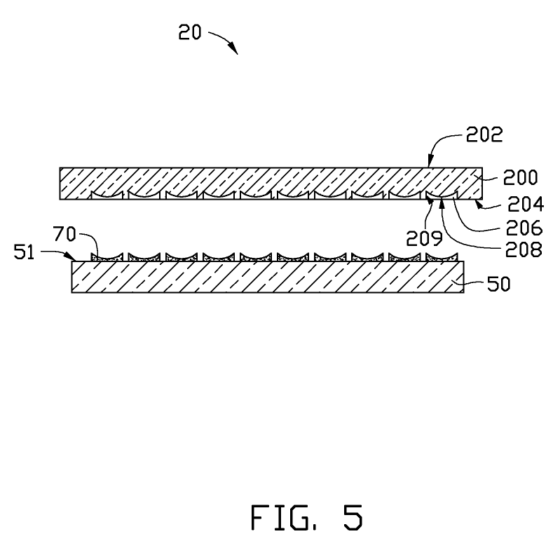

In step 4, referring to FIG. 5, the mold 20 is removed from the lenses 70, thus obtaining the lens array.

In the above exemplary method, the present mold 20 is used to produce the lenses 70 in press-molding using wafer-level techniques. Accordingly, the lens 70 has a small size, so camera modules (not shown) employing the lenses 70 are correspondingly small. Therefore, the lens 70 meets the miniaturization requirement of camera modules.

Furthermore, in the above exemplary method, since the molding cavities 206 are defined in the second surface 204, most/all of the optical material 70 is restricted in the molding cavities 206. Hence, little or none of the optical material 70 leaks from the molding cavities 206. Accordingly, less or none of the optical material 70 is wasted.

It is to be understood that in other methods, only a large blob 40 of the optical material is deposited on a surface 51 of the substrate 50 in step 1. Therefore, a lens array made by such method includes a plurality of connecting parts (not shown) formed between adjacent lenses 70. Accordingly, after the lens array is done, the lens array is cut into a plurality of individual lenses 70.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope and the spirit of the appended claims.

What is claimed is:

1. A mold comprising:
a base having a first surface and a second surface at two opposite sides thereof;
a plurality of molding cavities defined in the second surface;
a plurality of convex molding surfaces located in the respective molding cavities above the second surface; and
a plurality of side surfaces located in the respective molding cavities, each side surface being connected between the second surface and a respective convex molding surface, each side surface and a corresponding convex molding surface cooperatively defining a respective molding cavity,
wherein each convex molding surface is positioned between the first surface and the second surface, and is entirely received in a corresponding molding cavity.

2. The mold of claim 1, wherein each side surface is substantially perpendicular to the second surface of the base.

3. The mold of claim 1, wherein a minimum thickness between a molding surface and the second surface is about in a range from 1 micron to 300 microns.

4. The mold of claim 3, wherein the minimum thickness between the molding surface and the second surface is about in a range from 100 microns to 200 microns.

5. The mold of claim 1, wherein the material of the mold is selected from the group consisting of metal, silicon, and polydimethylsiloxane (PDMS).

6. The mold of claim 1, wherein each molding surface is selected from the group consisting of a spherical surface and an aspherical surface.

7. A mold comprising:
a base having a first surface and a second surface at two opposite sides thereof;
a plurality of molding cavities defined in the second surface;
a plurality of convex molding surfaces relative to the first surface; and
a plurality of side surfaces, each side surface being connected between the second surface and a respective convex molding surface, each side surface and a corresponding convex molding surface cooperatively defining a respective molding cavity,
wherein each convex molding surface is entirely received in a respective molding cavity, and a maximum distance between each convex molding surface and the first surface is less than a thickness of the base.

8. The mold of claim 7, wherein each side surface is substantially perpendicular to the second surface of the base.

9. The mold of claim 7, wherein a minimum thickness between a molding surface and the second surface is about in a range from 1 micron to 300 microns.

10. The mold of claim 9, wherein the minimum thickness between the molding surface and the second surface is about in a range from 100 microns to 200 microns.

11. The mold of claim 7, wherein the material of the mold is selected from the group consisting of metal, silicon, and polydimethylsiloxane.

12. The mold of claim 7, wherein each molding surface is selected from the group consisting of a spherical surface and an aspherical surface.
